(19) United States
(12) Patent Application Publication
(10) Pub. No.: US 2007/0295658 A1
(43) Pub. Date: Dec. 27, 2007

(54) ADJUSTABLE BARREL-NECK CONNECTOR

(76) Inventors: Richard Gaiser, Pendleton, NY (US); John B. Sanborn, Cheektowaga, NY (US); Tony Scime, East Aurora, NY (US)

Correspondence Address: SPENCER, FANE, BRITT & BROWNE, 1000 WALNUT STREET, SUITE 1400, KANSAS CITY, MO, 64106-2140, US

(21) Appl. No.: 11/765,309

(22) Filed: Jun. 19, 2007

Related U.S. Application Data
(60) Provisional application No. 60/805,840, filed on Jun. 26, 2006.

(51) Int. Cl. B01D 25/21; B01D 21/28

(52) U.S. Cl. 210/348; 210/541

(57) ABSTRACT

An adjustable barrel-neck connector (10) for use in a filter press, comprising multiple interconnecting components (12,14,16) and operable to connect feed holes in first and second layers of filter media (20,22) through a feed passage in a filter plate (24), wherein the length of the connector (10) is adjustable to accommodate filter plates of different thicknesses. More specifically, first and second flanged end components (12,16) each include a plurality of inclined teeth (32), and a tubular connecting component (14) includes first and second pluralities of teeth (44,46) inclined in opposite directions. When each end component (12,16) is pushed onto a respective end of the connecting component (14), the plurality of teeth (32) of the end component (12,16) engage a respective one of the pluralities of teeth (44,46) of the connecting component (14) such that the relative inclinations of the engaged teeth (32,44; 32,46) prevent inadvertent separation.

### RELATED APPLICATIONS

The present U.S. non-provisional patent application is related to and claims priority benefit of an earlier-filed U.S. provisional patent application having the same title, Ser. No. 60/805,840, filed Jun. 26, 2006. The identified earlier-filed application is hereby incorporated by reference into the present application.

### FIELD OF THE INVENTION

The present invention relates to connectors for connecting layers of filter media through filter plates in filter presses. More specifically, the present invention concerns a barrel-neck connector comprising multiple interconnecting components and operable to connect feed holes in first and second layers of filter media through a feed passage in a filter plate, wherein the length of the connector is adjustable to accommodate filter plates of significantly different thicknesses

### BACKGROUND OF THE INVENTION

Filter presses are often used to process slurries by separating liquid components from solid components. A filter press generally comprises a plurality of two-sided filter plates, with each pair of adjacent filter plates defining a chamber between them. Each side of each filter plate is covered with a layer of filter media. A feed hole is provided in each layer of filter media and a corresponding feed passage extends through the filter plate so as to allow the slurry to move into successive chambers in the filter press. As the process progresses, the solid components are trapped within the chambers, and the liquid components escape through the filter media. It is important, however, to prevent the slurry from escaping the chambers through failure points associated with the feed holes.

It is known to define the connection between feed holes by creating a tubular structure from the filter media, and stitching the ends of the tubular structure to respective layers of the filter media. The filter media is then installed on the filter plate by passing one of the layers through the feed passage extending through the filter plate. The layers are then properly arranged on respective sides of the filter plate, and the tubular structure connects the two layers and lines the feed passage through the filter plate. Unfortunately, this solution suffers from several problems and disadvantages, including, for example, that the stitching operation is undesirably time-consuming, and that the stitch holes are points of potential failure and leakage. Furthermore, the layers of filter media can harden as a result of use, such that removing the layers for washing and reuse, or for replacing a single damaged layer, can be difficult or impossible without cutting or otherwise destroying them.

It is also known to define the connection between feed holes by creating a tubular structure from a flexible material. The ends of the tubular structure are provided with flanges to which respective layers of filter media are glued or welded. Unfortunately, this solution addresses only the problem of potential failure and leakage resulting from stitching, and does not address the aforementioned and other problems associated with installing and removing the layers of filter media.

It is therefore also known to provide the tubular structure in the form of a two-part connector, i.e., a first part associated with one layer of the filter media, and a second part associated with the other layer, thereby eliminating the need to pull one layer through the passage in the filter plate. Instead, the layers are properly arranged on respective sides of the filter plate and the two parts of the tubular structure are inserted into the passage and secured. Unfortunately, the seal between the two parts can leak, especially in high pressure applications.

Furthermore, even the most advanced prior art connectors can be difficult to quickly and easily assemble and install in a field or operating environment, and can be similarly difficult to remove when it is desired to clean or service the filter media. Additionally, prior art connectors do not allow for significant adjustability to accommodate filter plates of different thicknesses. Additionally, prior art connectors require that the layers of filter media be separate and distinct pieces, which can hinder installation.

Due to these and other problems and disadvantages in the prior art, a need exists for an improved connector.

### SUMMARY OF THE INVENTION

The present invention overcomes the above-identified and other problems and disadvantages by providing an adjustable barrel-neck connector for use in a filter press, comprising multiple interconnecting components and operable to connect feed holes in first and second layers of filter media through a feed passage in a filter plate, wherein the length of the connector is adjustable to accommodate filter plates of different thicknesses

In one embodiment the connector broadly comprises an end component including an open-ended body having a flange at one end to facilitate attachment of one of the first and second layers of the filter media, and a plurality of teeth inclined toward the flange; and a connecting component for insertion into the feed passage, the connecting component including an open-ended body, and a plurality of teeth inclined toward one end of the body, and wherein when the end component and the connecting component are pushed together, the plurality of teeth of the end component engage the plurality of teeth of the connecting component such that the relative inclinations of the engaged teeth prevent the end component and the connecting component from inadvertently separating.

In another embodiment, the connector comprises first and second end components, each including the open-ended body having the flange at one end to facilitate attachment of the respective one of the first and second layers of the filter media, and the plurality of teeth inclined toward the flange; and the connecting component for insertion into the feed passage, the connecting component including the open-ended body, the first plurality of teeth inclined toward a first end of the body, and a second plurality of teeth inclined toward a second end of the body, such that the first and second pluralities of teeth are oppositely inclined, and wherein, for each of the first and second end components, when the end component is pushed onto a respective one of the first and second ends of the connecting component, the plurality of teeth of the end component engage a respective one of the first and second pluralities of teeth of the connecting component such that the relative inclinations of the engaged teeth prevent the end component and the connecting component from inadvertently separating.

In various embodiments, the connector may further incorporate any one or more of the following features. For each of the first and second end components, the plurality of teeth of the end component may project inwardly from an inner surface of the body of the end component, and the plurality of teeth of the connecting component project outwardly from an outer surface of the body of the connecting component, and the connecting component fits within the end component. Alternatively, this configuration may be reversed such that the end component fits within the connecting component. Each tooth of the plurality of teeth of the first and second end components and the first and second pluralities of teeth of the connecting component may have a triangular cross-sectional shape, i.e., acute, right, or obtuse. Each of the first and second end connectors may further include an attachment structure which is secured to the flange and to which the filter media is welded. For each of the first and second end components, the flange may includes first and second pieces between which the filter media is clamped. Depending on the thickness of the filter plate, the connecting component may be insertable through at least one of the first and second end components so that a removable excess portion of the connecting component projects beyond the flange. The connecting component may further include a stop element located substantially between the first and second pluralities of teeth and defining a maximum distance that at least one of the first and second end components can travel on the connecting component.

From the discussion set forth herein, one with ordinary skill in the art will understand and appreciate that the present invention provides significant advantages over the prior art, including, for example, that it provides a connector which can be quickly and easily assembled and installed, and which is adjustable so as to be universally useable with filter plates of significantly different thicknesses. Furthermore, the connector allows for quickly, easily, and non-destructively removing the filter media for maintenance or replacement.

These and other features of the present invention are described in greater detail in the section titled DETAILED DESCRIPTION OF THE INVENTION, below.

### BRIEF DESCRIPTION OF THE DRAWING FIGURES

The present invention is described herein with reference to the following drawing figures, which are not necessarily to scale:

FIG. 1 is an exploded view of an embodiment of the connector of the present invention, including first and second end components and a connecting component;

FIG. 2 is an isometric view of an end component;

FIG. 3 is a cross-sectional view of the end component;

FIG. 4 is a fragmentary cross-sectional view of an embodiment of a flange portion of the end component, wherein the flange portion comprises two parts and is shown in the process of being secured to the filter media;

FIG. 5 is a fragmentary cross-sectional view of the embodiment of FIG. 4, when the flange portion is shown secured to a layer of filter media;

FIG. 6 is a cross-sectional view illustrating a first step in a process of installing the connector, wherein a layer of filter media is secured to each end component;

FIG. 7 is a cross-sectional view illustrating a second step in the process, wherein a connecting component is being connected to the second end component;

FIG. 8 is a cross-sectional view of the connected connecting and second end components;

FIG. 9 is a cross-sectional view illustrating a third step in the process, wherein the first end component is being connected to the connecting component; and

FIG. 10 is a cross-sectional view of the connector, with the end components secured to respective layers of a single piece of filter media, being installed on a filter plate.

### DETAILED DESCRIPTION OF THE INVENTION

With reference to the figures, an adjustable barrel-neck connector 10 is herein described, shown, and otherwise disclosed in accordance with a preferred embodiment of the present invention. Broadly, the connector 10 comprises multiple interconnecting components 12,14,16 and is operable to connect feed holes in first and second layers of filter media 20,22 through a feed passage in a filter plate 24, wherein the length of the connector 10 is adjustable to accommodate filter plates of significantly different thicknesses.

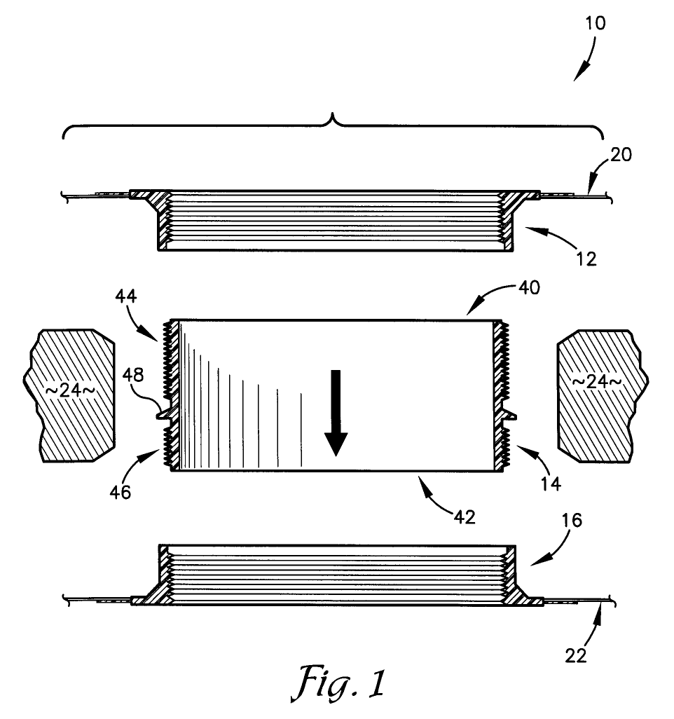

Referring to FIG. 1, one embodiment of the connector 10 broadly comprises a first end component 12; a connecting component 14; and a second end component 16. Each component 12,14,16 may be constructed from any suitable material such as, for example, a rubber such as EPDM; a thermoplastic such as polypropylene, polyethylene, polyester, nylon, PTFE, or PVDF; or a material combining the properties of thermoplastics and rubber such as TPVs, TPEs, or TPRs (one such material is available under the brand name Santoprene®). Similarly, the filter media 20,22 may be constructed from any suitable natural, artificial, or combination material. For applications involving food, the components 12,14,16 and filter media 20,22 may be constructed from suitable food-grade materials; for other applications, the nature of the materials may vary accordingly, depending particularly on the conditions under which the connector 10 may be used.

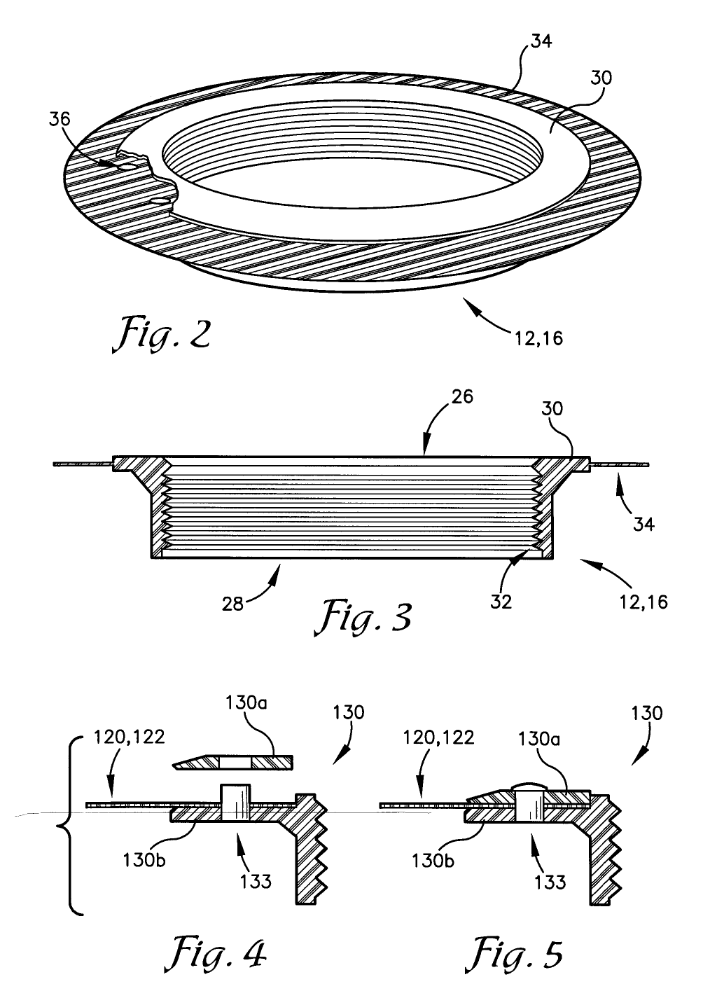

Referring also to FIGS. 2 and 3, each end component 12,16 may be substantially identical and includes a passage-defining, e.g., tubular, body presenting first and second open ends 26,28, and a flange 30 projecting outwardly from the first end 26. Each end component 12,16 also includes a plurality of projections 32, hereinafter referred to as “teeth”, or other engagement structures projecting inwardly from an inner surface of the body between the first and second ends 26,28, wherein the teeth 32 present at least a portion of one surface which is inclined toward the first, or flanged, end 26 of the body. In the illustrated embodiment, the teeth 32 present first and second surfaces, with the first surface being inclined toward the flanged end 26 of the body, and the second surface being inclined toward the non-flanged end 28, giving each tooth the cross-sectional shape of an acute triangle. In an alternative embodiment, the first surface is inclined toward the flanged end 26 of the body, and the second surface is parallel with or inclined away from the non-flanged end 28, giving each tooth the cross-sectional shape of a right or obtuse triangle. In yet other embodiments, the teeth 32 may have other polygonal (e.g., rectangular, trapezoidal), rounded, or complex cross-sectional shapes. In each case, the teeth 32 of the end component 12,16 interlock or otherwise engage at an engagement surface, whether inclined or not, a respective corresponding plurality of teeth 44,46 of the connecting component 14, as discussed below.

In one embodiment, the filter media 20,22 is attached directly to the flanges 30 of the end components 12,16. Such attachment may be accomplished using any suitable process, such as, for example, stitching, gluing, welding, or other chemical or mechanical mechanism. One class of attachment processes involves applying heat and pressure, wherein the heat can be generated by ultrasonic vibration, hot air, hot wedge, hot plate, radio frequency stimulation, or magnetic induction.

In an alternative embodiment, shown in FIGS. 2 and 3, each end component 12,16 also includes an attachment ring 34 molded into or otherwise attached to or associated with the flange 30. The attachment ring 34 facilitates attaching the filter media 20,22 to the connector 10. The attachment ring 34 may be constructed from any suitable material such as, for example, woven cloth, needled felt, or non-woven cloth or paper produced using small thermoplastic fibers, heat, and pressure, or a strong, non-fibrous film material, and may be coated with plastic, rubber, or resin to facilitate bonding or welding it to the filter media. As shown in FIG. 2, the attachment ring 34 may present openings 36 or other structures on or near an inner edge to facilitate material flow, during molding, through selected areas of the attachment ring 34 and thereby enhance the mechanical connection to the flange 30.

In yet another alternative embodiment, shown in FIGS. 4 and 5, the flanges 130 comprise first and second pieces 130a,130b between which the filter media 120,122 is trapped. More specifically, the filter media 120,122 is positioned on the second piece 130b, and the first piece is then positioned over the filter media 120,122 and secured so as to trap the filter media 120,122 therebetween. A plurality of pins 133 may be inserted through aligned holes in the first and second pieces 130a,130b to mechanically secure the first and second pieces 130a,130b together.

Referring again to FIG. 1, the connecting component 14 also includes a passage-defining, e.g., tubular, body presenting first and second open ends 40,42. The outer diameter or other outer dimension of the connecting component 14 is less than the inner diameter or other inner dimension of the end components 12,16, such that at least portions of the connecting component 14 associated with the open ends 40,42 can be closely received within respective end components 12,16. The connecting component 14 also includes first and second sets of teeth 44,46 or other engagement structures projecting outwardly from an outer surface of the body, with each set of teeth 44,46 corresponding to a respective one of the first and second ends 40,42, and each set of teeth 44,46 including at least a portion of one surface which is inclined toward the respective opposite open end 40,42 of the body. The connecting component 14 may also include a stop element 48 projecting outwardly from the outer surface of the body and located substantially between the first and second sets of teeth 44,46.

In one embodiment, the connecting component 14 is made of, or provided with a sleeve made of, a compressible material or otherwise adapted in order to compress, i.e., achieve a “compression fit”, when the first and second components 12,16 are pushed onto the connecting component 14, and thereby further minimize the risk of leakage.

The connecting component 14 has been described as being received within the end components 12,16. In an alternative embodiment, the basic design is appropriately changed so that at least a portion of each end component 12,16 associated with the second open end 28 is received within the connecting component 14. In either case, the passage defined by the assembled connector 10 through the filter plate 24 preferably presents substantially smooth walls so as not to hinder or otherwise interfere with passage of the slurry therethrough.

The connector 10 may also include appropriate locational devices, such as arrows or notches, to guide assembly of the connector components 12,14,16 and ensure that both layers of filter media 20,22 are properly aligned with the filter plate 24 and with each other.

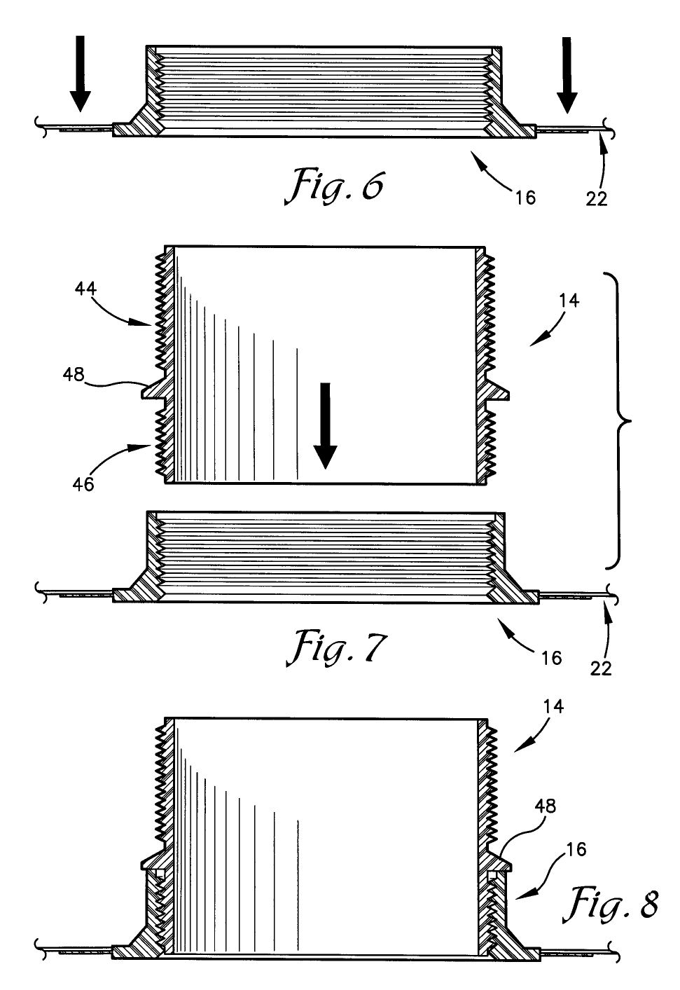

Referring to FIGS. 6-9, the connector 10 may be assembled as follows. As shown in FIG. 6, corresponding holes in the first and second layers of filter media 20,22 are aligned with the first open ends 26 of the end components 12,16, and the layers 20,22 are attached to the flanges 30,130 or attachment rings 34 of the first and second end components 12,16, respectively.

As shown in FIG. 7, the second open end 42 of the connecting component 14 is aligned with the second open end 28 of the second end component 16 and pushed thereinto until, as shown in FIG. 8, the stop element 48 contacts the second end component 16 and prevents further travel. In so doing, the plurality of teeth 32 on the inner surface of the second end component 16 engage the second set of teeth 46 on the outer surface of the connecting component 14, and the relative inclinations of the engaged teeth 32,46 thereafter prevent inadvertent disconnection of the two components 14,16. This connection mechanism can be characterized as belonging to a class of connection mechanisms which are sometimes referred to as “zip” connectors.

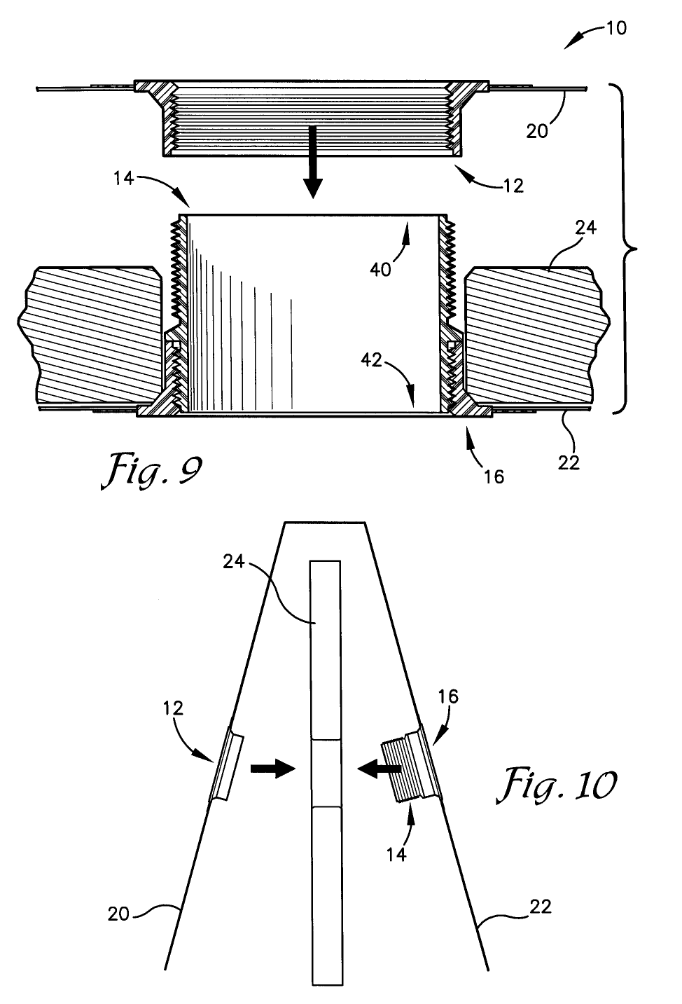

As shown in FIG. 9, the combined second end and connecting components 14,16 are positioned on the filter plate 24 with the first flanged end 26 of the second end component 16 being substantially flush against one side of the filter plate 24 and the first open end 40 of the connecting component 14 extending through the feed passage in the filter plate 24 and toward or out the opposite side of the filter plate 24. The second open end 28 of the first end component 12 is aligned with the first open end 40 of the connecting component 14 and pushed thereonto until the flanged end 30 of the first end component 12 is substantially flush against the second side of the filter plate 24. In so doing, the plurality of teeth 32 on the inner surface of the first end component 12 engage the first set of teeth 44 on the outer surface of the connecting component 14, and the relative inclinations of the engaged teeth 32,44 thereafter prevent inadvertent disconnection of the two components 12,14.

Depending on the thickness of the filter plate 24, a portion of the first open end 40 of the connecting component 14 may extend beyond the first open end 26 of the first end component 12. If so, the excess portion may be removed, such as by cutting. In one contemplated removal process, an appropriate tool is used to score the inner surface of the connecting component 14 where the excess portion begins, after which the excess portion can be snapped off at the scoreline.

Referring also to FIG. 10, it will be appreciated that, because the connector 10 is assembled on the filter plate 24 during installation of the filter media 20,22, rather than fully pre-assembled and pulled through the feed passage in the filter plate 24, the filter media 20,22 can be provided as a single piece, or sheet, which is folded around the filter plate 24 during installation, rather than as two separate pieces.

From the foregoing discussion, one with ordinary skill in the art will understand and appreciate that the present invention provides significant advantages over the prior art, including, for example, that it provides a connector which can be quickly and easily assembled and installed, and which is adjustable so as to be universally useable with filter plates of significantly different thicknesses. Furthermore, the connector allows for quickly, easily, and non-destructively removing the filter media for maintenance or replacement.

Although the invention has been disclosed with reference to various particular embodiments, it is understood that equivalents may be employed and substitutions made herein without departing from the scope of the invention as recited in the claims. For example, it will be appreciated that the second end component 16 and the connecting component 14, though described herein as separate pieces, may be manufactured as a single piece which may be substantially identical to the combined components 14,16 shown in of FIG. 8, making the connector a two-component connector rather than a three-component connector.

Having thus described the preferred embodiment of the invention, what is claimed as new and desired to be protected by Letters Patent includes the following:

1. A connector for connecting first and second layers of a filter media through a feed passage in a filter plate in a filter press, the connector comprising:
an end component including—
an open-ended body including a flange at one end to facilitate attachment of one of the first and second layers of the filter media, and
a plurality of projections; and
a connecting component for insertion into the feed passage, the connecting component including—
an open-ended body, and
a plurality of corresponding projections,
wherein when the end component and the connecting component are pushed together, the plurality of projections of the end component engage the plurality of corresponding projections of the connecting component such that the engaged projections prevent the end component and the connecting component from inadvertently separating.

2. The connector as set forth in claim 1, wherein—
there are first and second end components; and
the connecting component includes first and second pluralities of corresponding projections,
wherein, for each end component, when the end component and the connecting component are pushed together, the plurality of projections of the end component engage a respective one of the first and second pluralities of corresponding projections of the connecting component such that the engaged projections prevent the end component and the connecting component from inadvertently separating.

3. The connector as set forth in claim 1, wherein, depending on the thickness of the filter plate, the connecting component can be pushed through the end component so that a removable excess portion of the connecting component projects beyond the flange.

4. A connector for connecting first and second layers of a filter media through a feed passage in a filter plate in a filter press, the connector comprising:
first and second end components, each including—
an open-ended body including a flange at one end to facilitate attachment of a respective one of the first and second layers of the filter media, and
a plurality of teeth, each including at least a portion of a surface inclined toward the flange; and
a connecting component for insertion into the feed passage, the connecting component including—
an open-ended body,
a first plurality of teeth, each including at least a portion of a surface inclined toward a first end of the body, and
a second plurality of teeth, each including at least a portion of a surface inclined toward a second end of the body, such that the first and second pluralities of teeth are oppositely inclined,
wherein, for each of the first and second end components, when the end component is pushed onto a respective one of the first and second ends of the connecting component, the plurality of teeth of the end component engage a respective one of the first and second pluralities of teeth of the connecting component such that the relative inclinations of the engaged teeth prevent the end component and the connecting component from inadvertently separating.

5. The connector as set forth in claim 4, wherein, for each of the first and second end components, the plurality of teeth of the end component project inwardly from an inner surface of the body of the end component, and the first and second pluralities of teeth of the connecting component project outwardly from an outer surface of the body of the connecting component, and the connecting component fits within the end component.

6. The connector as set forth in claim 4, wherein, for each of the first and second end components, the plurality of teeth of the end component project outwardly from an outer surface of the body of the end component, and the first and second pluralities of teeth of the connecting component project inwardly from an inner surface of the body of the connecting component, and the end component fits within the connecting component.

7. The connector as set forth in claim 4, wherein each tooth of the plurality of teeth of the first and second end components and the first and second pluralities of teeth of the connecting component has a triangular cross-sectional shape.

8. The connector as set forth in claim 4, wherein each of the first and second end connectors further includes an attachment structure which is secured to the flange and to which the filter media is welded.

9. The connector as set forth in claim 4, wherein, for each of the first and second end components, the flange includes first and second pieces between which the filter media is clamped.

10. The connector as set forth in claim 4, wherein, depending on the thickness of the filter plate, the connecting component can be pushed through at least one of the first and second end components so that a removable excess portion of the connecting component projects beyond the flange.

11. The connector as set forth in claim 4, wherein the connecting component further includes a stop element located substantially between the first and second pluralities of teeth and defining a maximum distance that at least one of the first and second end components can travel on the connecting component.

12. The connector as set forth in claim 4, wherein the connecting component includes a compressible material which is compressed by the first and second end components when the first and second end components are pushed onto the connecting component.

13. An assembly for use in a filter press, the assembly comprising:
a filter plate having first and second sides and a feed passage extending therebetween;
first and second layers of a filter media, each being associated with a respective one of the first and second sides of the filter plate, and each including a feed hole aligned with the feed passage; and
a connector for connecting the first and second layers of the filter media through the feed passage, the connector including—
first and second end components, each including—
an open-ended body including a flange at one end to facilitate attachment of a respective one of the first and second layers of the filter media, and
a plurality of teeth, each including at least a portion of a surface inclined toward the flange; and
a connecting component for insertion into the feed passage, the connecting component including—
an open-ended body,
a first plurality of teeth, each including at least a portion of a surface inclined toward a first end of the body, and
a second plurality of teeth, each including at least a portion of a surface inclined toward a second end of the body, such that the first and second pluralities of teeth are oppositely inclined,
wherein, for each of the first and second end components, when the end component is pushed onto a respective one of the first and second ends of the connecting component, the plurality of teeth of the end component engage a respective one of the first and second pluralities of teeth of the connecting component such that the relative inclinations of the engaged teeth prevent the end component and the connecting component from inadvertently separating.

14. The assembly as set forth in claim 13, wherein, for each of the first and second end components, the plurality of teeth of the end component project inwardly from an inner surface of the body of the end component, and the first and second pluralities of teeth of the connecting component project outwardly from an outer surface of the body of the connecting component, and the connecting component fits within the end component.

15. The assembly as set forth in claim 13, wherein, for each of the first and second end components, the plurality of teeth of the end component project outwardly from an outer surface of the body of the end component, and the first and second pluralities of teeth of the connecting component project inwardly from an inner surface of the body of the connecting component, and the end component fits within the connecting component.

16. The assembly as set forth in claim 13, wherein each tooth of the plurality of teeth of the first and second end components and the first and second pluralities of teeth of the connecting component has a triangular cross-sectional shape.

17. The assembly as set forth in claim 13, wherein, for each of the first and second end components, the filter media is welded directly to the flange.

18. The assembly as set forth in claim 13, wherein each of the first and second end connectors further includes an attachment structure which is secured to the flange and to which the filter media is welded.

19. The assembly as set forth in claim 13, wherein, for each of the first and second end components, the flange includes first and second pieces between which the filter media is clamped.

20. The assembly as set forth in claim 13, wherein, depending on the thickness of the filter plate, the connecting component can be pushed through at least one of the first and second end components so that a removable excess portion of the connecting component projects beyond the flange.

21. The assembly as set forth in claim 13, wherein the connecting component further includes a stop element located substantially between the first and second pluralities of teeth and defining a maximum distance that at least one of the first and second end components can travel on the connecting component.

22. The assembly as set forth in claim 13, wherein the connecting component includes a compressible material which is compressed by the first and second end components when the first and second end components are pushed onto the connecting component.
